(19) United States
(12) Patent Application Publication
(10) Pub. No.: US 2006/0240174 A1
(43) Pub. Date: Oct. 26, 2006

(54) Method for the reduction of acrylamide formation

(76) Inventors: Mun Yhung Jung, Jeollabuk-do (KR); Dong-Seong Choi, Jeollabuk-do (KR); Jin-Woo Ju, Jeollabuk (KR)

Correspondence Address: Neil A DuChez;RENNER OTTO BOISSELLE & SKLAR, 1621Euclid Ave, 19th Floor, Cleveland, OH, 44115, US

(21) Appl. No.: 10/540,188

(22) PCT Filed: Sep. 2, 2003
(86) PCT No.: PCT/KR03/01796

§ 371 Date: Jun. 9, 2006

(30) Foreign Application Priority Data
Jan. 3, 2003 (KR) 10-2003-0000391
Jun. 26, 2003 (KR) 10-2003-0042189

(51) Int. Cl. A23G 3/00

(52) U.S. Cl. 426/658

(57) ABSTRACT

The present invention relates to a method for the reduction of acrylamide formation, in which a nucleophilic a-amino group (—NH2) is protonated and converted into a non-nucleophilic amine (—NH3+). The inventive method has the effect of allowing the formation of acrylamide to be highly reduced by simple treatment with a pH-lowering agent. Particularly, when applied to foods or foods ingredients, the inventive method has the effect of allowing the formation of acrylamide to be highly reduced without affecting the flavor and color of the foods or foods ingredients.

### TECHNICAL FIELD

The present invention relates to a method for reducing the formation of acrylamide classified as a potential cancer-causing agent.

### BACKGROUND ART

Acrylamide, a colorless, clear, crystalline solid, is a chemical that is formed in foods during frying or baking at a high temperature above 120° C. This acrylamide has been classified as a potential cancer-causing agent by the International Agency for Research on Cancer (IARC) of the World Health Organization (WHO) since the year 1944 (see, IARC, Acrylamide, 60, 389, 1994). It is reported that acrylamide causes cancer in rats or fruit flies, particularly in adrenals and testicles of mice or rats exposed to acrylamide for a considerable time. Accordingly, acrylamide is regarded as one of highly potential cancer-causing agent for human. Furthermore, acrylamide is toxic to the nervous system of animals or humans. On April 2002, a research team of S. Tornqvist in Sweden first reported that crisps and biscuits processed at high temperature contain higher level of acrylamide than recommended by WHO (see, E. Tareke et al., J. Agric. Food Chem., 50, 4998-5006, 2002). After that on December 2002, acrylamide was detected in eight different foods in Korea following Europe, United States and Japan. A study on the content of actylamide in heated foods, which was conducted by a research team (led by Sang-suk, Oh, professor of Department of Food and Nutrition, Ewha Womans University) according to a request of the Korea Food and Drug Administration, showed that acrylamide was detected in eight of ten different marketed foods and the amount of acryamide is as follows: fried potatoes (French fries) (341-1869 ppb), potato chips (854-1081 ppb), cereals (51-283 ppb), biscuits (115-241 ppb), instant coffee powders (60-220 ppb), chocolates (47-63 ppb), and breads such as slice of bread and doughnut (30-36 ppb). However, acrylamide was not detected in raw potato and boiled rice.

With respect to the mechanism of acrylamide formation, two research teams (one led by professor Donald Mottram of the University of Reading in England, and the other by Richard Stadler of Nestlé Research Center in Switzerland) have found that acrylamide is produced by the heat treatment of certain amino acids and sugars at high temperature. Furthermore, the two research teams have found that acrylamide is produced by the Strecker degradation mechanism of the Maillard reaction (see, D. S. Mottram et al., Nature, 419, 448-449, 2002; R. H. Stadler et al., Nature, 419.449-450, 2002).

The Strecker degradation mechanism is initiated by the nucleophilic attack of a pair of unshared electrons of α-amino acid (—NH₂) of the asparagine on a partially positive carbonyl carbon of an aldehyde group of a dicarbonyl compound, followed by the loss of a proton from the nitrogen and the gain of a proton by the oxygen. The dicarbonyl compound is produced by the reaction of a monocarbonyl compound, such as glucose, with an amino group and then the degradation of the compound. When this reaction is initiated, a Schiff base is formed on which decarboxylation and deamination occur to form acrylamide (see, Scheme 1 below).

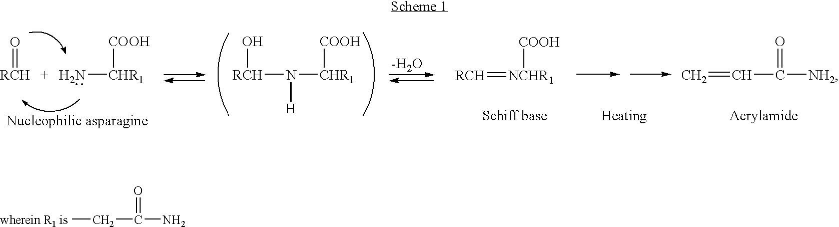

Meanwhile, the Maillard reaction is one of processing methods, which have often been used by food companies for several decades in order to make the taste and flavor of foods good. Also, it is a processing method of foods, which is most frequently used today. However, the Maillard reaction leads to the formation of acrylamide in foods as described above. For example, heating to a temperature of 170-180° C. in the production of confectioneries results in the reaction of reducing sugars, such as glucose, with amino acids and the degradation of the compound to form a dicarbonyl compound, which then reacts with asparagine to form acrylamide. Generally, the baking of confectioneries and breads is conducted at an oven temperature above about 170° C. and the frying of fried potatoes and potato chips is conducted at high temperature, so that acrylamide is easily formed in such foods.

Until now, as effective methods for reducing the formation of acrylamide, there are a method of processing foods by heating at low temperature and a method of steaming or boiling foods. The US Food and Drug Administration (FDA) recommends that foods are not fried or baked at high temperature for an extended period of time, since acrylamide is not detected in foods heated below 120° C. Thus, a method capable of effectively reducing the formation of acrylamide occurring when processing foods at a high temperature above 120° C. was not developed by this time.

### DISCLOSURE OF THE INVENTION

Accordingly, the present inventors have conducted many studies in an attempt to develop a method for effectively reducing the formation of acrylamide, and consequently, found that when a nucleophilic α-amino group (—NH₂) of the asparagine is protonated and converted into a non-nucleophilic amine (—NH₃⁺), the formation of acrylamide can be effectively reduced. On the basis of this point, the present invention has been completed.

Therefore, an object of the present invention is to provide a method for the reduction of acrylamide formation, comprising the step of protonating a nucleophilic α-amino group (—NH₂) of the asparagines, thereby converting into a non-nucleophilic amine (—NH₃⁺).

### BRIEF DESCRIPTION OF THE DRAWINGS

FIG. 1 is the chromatogram of acrylamide formed upon the heat treatment of a mixture of asparagine and glucose.

### DETAILED DESCRIPTION OF THE INVENTION

To achieve the above objects, the present invention provides a method for the reduction of acrylamide formation, comprising the step of protonating a nucleophilic α-amino group (—NH₂) of the asparagine, thereby converting into a non-nucleophilic amine (—NH₃⁺).

The method for reducing the formation of acrylamide according to the present invention is based on a principle that a nucleophilic α-amino group (—NH₂) of the asparagine is protonated and converted into a non-nucleophilic amine (—NH₃⁺) such that nucleophilic electrons as unshared electrons could be prevented from reacting with an partially positive carbonyl carbon of a dicarbonyl compound to reduce the formation of a Schiff base, thereby reducing the formation of acrylamide (see, Scheme 2 below).

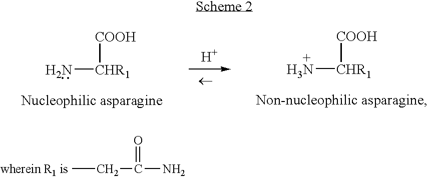

Thus, the present invention provides a method for the reduction of acrylamide formation, comprising the step of protonating a nucleophilic amino group (—NH₂) of the asparagine, thereby converting into a non-nucleophilic amine (—NH₃⁺).

In the method of the present invention, the protonation of the nucleophilic amino group can be carried out by treatment with a pH-lowering agent.

Furthermore, the method for reducing the formation of acrylamide according to the present invention can be applied to all kinds of industrial fields where acrylamide may be formed, thus having a harmful effect on the health of humans. Preferably, it can be applied to foods, feeds or cosmetics, and more preferably foods or foods ingredients.

Thus, the present invention provides a method for the reduction of acrylamide formation, in which foods are treated with the pH-lowering agent.

When the method for reducing the formation of acrylamide according to the present invention is applied to foods or foods ingredients, the treatment of the foods or foods ingredients with the pH-lowering agent can be carried out before subjecting the foods to heat treatment.

Treatment of the foods or foods ingredients with the pH-lowering agent is preformed by adding, mixing or spraying the pH-lowering agents or soaking the foods or food ingredients in the pH-lowering agent solutions.

As used herein, the term “heat treatment” includes, but not limited to, all kinds of food processing methods, which are thermally treatment of food at high temperature. Preferably, it refers to methods of processing foods at a high temperature above 120° C., such as frying, baking, roasting, high temperature extrusion and high temperature injection.

Foods or foods ingredients, to which the method for reducing the formation of acrylamide according to the present invention can be applied, include all kinds of foods where acrylamide can be formed by heat treatment. Preferably, they include foods or foods ingredients containing amino acids, sugars, carbonyl compounds and the like so that, upon heat treatment, a pair of unshared electrons at an α-amino group of the asparagine can nucleophilically attack a carbonyl carbon at an aldehyde group of a dicarbonyl compound to form a Schiff base from which acrylamide can be formed. More preferably, they include carbohydrate foods. Examples of these carbohydrate foods include, but not limited to, fried potatoes, fried noodles, biscuits, breads, corn flakes, potato crisps, cereals, and raw materials for the production thereof.

As used herein, the term “pH-lowering agent” refers to an additive capable of lowering pH. When foods are treated with the pH-lowering agent, a substance approved by a food-related administration for use as a food additive is preferably used as the pH-lowering agent.

When foods or foods ingredients are treated with the pH-lowering agent, the foods are can be treated such that their pH is lower than the intrinsic pH of the foods or a pH in the prior food processing processes. More preferably, the foods can be treated such that their pH is about 0.1-3.0 units lower than the intrinsic pH of the foods or foods ingredients. Most preferably, this treatment is conducted such that the pH of the foods is about 0.5-2.0 units lower than the intrinsic pH of the foods. For this purpose, the pH-lowering agent is added to the foods at a concentration of about 0.001-10.0% by weight, preferably about 0.01-10.0% by weight, and more preferably about 0.02-2.0% by weight.

Examples of the pH-lowering agent, which can be used in the present invention, include organic acid or its salt, buffer solution containing the organic acid or its salt, inorganic acid or its salt, buffer solution containing the inorganic acid or its salt, fruit juice, and a mixture thereof. Examples of such organic acids include citric acid, malic acid, acetic acid, lactic acid, succinic acid, tartaric acid, ascorbic acid, and adipic acid. Preferably, citric acid can be used in the present invention. Examples of inorganic acids include phosphoric acid, hydrochloric acid, sulfuric acid and pyrophosphoric acid. Examples of salts of inorganic acid include monosodium phosphate and monopotassium phosphate. Citric acid-sodium citrate buffer solution or citric acid-sodium phosphate buffer can be used as the buffer solution containing organic acid or its salt. Sodium phosphate or potassium phosphate buffer solution can be used as the buffer solution containing inorganic acid or its salt. Examples of such fruit juice include lemon-, plum-, orange-, apricot-, citron- and lime juices, which have high organic acid content. Further examples of the pH-lowering agent, which can be used in the present invention, include all kinds of organic acids, inorganic acids, their salts, and buffer solutions containing such acids or salts, which were approved by a worldwide food-related administration, such as the Korea Food and Drug Administration (KFDA) or the US Food and Drug Administration (FDA), for use as food additives.

In one embodiment of the present invention, 500 ml of 0.1% or 0.2% citric acid solution was added to corn grits as a raw material of corn chips, thereby lowering the pH of the corn grits. Next, the corn grits were fried with oil at 180° C., after which the amount of acrylamide formed in the resulting corn chips was measured. As a result, it was found that the test group added with the citric acid solution showed a significant reduction in the formation of acrylamide as compared to a control group. Furthermore, the higher the concentration of citric acid, the inhibition % of acrylamide formation was increased such that the amount of formed acrylamide was reduced as compared to the control group by 82.4% (see, Example 1). The test group added with citric acid showed little or no change in flavor, and as the concentration of the added citric acid is increased, the test group showed a tendency to be slightly lighter in color (see, Example 2).

In another example of the present invention, 500 ml of 0.1% or 0.2% citric acid solution was added to corn grits as a raw material of corn chips, thereby lowering the pH of the corn grits. Next, the corn grits were steamed at 121° C. for 60 minutes, and then heated in an oven at 225° C. for 1 minute and 40 seconds or for 2 minutes, after which the amount of acrylamide formed in the resulting corn chips was measured. As a result, it was found that the test group added with the citric acid solution showed a significant reduction in formation of acrylamide as compared to a control group added with no citric acid solution. Furthermore, the higher the concentration of the added citric acid, the inhibition % of acrylamide formation was increased such that the amount of formed acrylamide was reduced as compared to the control group by 72.8% (see, Example 3). The test group added with citric acid showed little or no difference in flavor and color from the control group (see, Example 4).

In still another embodiment, potatoes, as a raw material of fried potatoes, was dipped in 1% or 2% citric acid solution, and fried with oil at 190° C. for 6 minutes and 30 seconds to produce fried potatoes. Then, the amount of acrylamide formed in the fried potatoes was measured. As a result it was found that the test groups dipped in the citric acid solution showed of 73.1% and 79.7% inhibition of acrylamide formation, indicating that the formation of acrylamide was greatly reduced (see, Example 5). The test group dipped in citric acid showed little or no change in flavor, and as the concentration of the citric acid is increased, the test group had a little sour flavor (see, Example 6).

In yet another embodiment of the present invention, to confirm the mechanism of the reduction of acryamide formation by the pH-lowering agent, the present inventors carried out a test using phosphate buffer model system. That is, present inventors carried out a test on acrylamide formation by adding asparagine and glucose to sodium phosphate buffer solution having a pH of 4.0-8.0, and heating the mixture in an oven at 150° C. for 30 minutes. Then, the inventors measured the amount of formed acrylamide according to a change in pH. The test results showed that the lower the pH, the lower the amount of formed acrylamide. Particularly, at a pH of 5.0 or 4.0, the inhibition % of acrylamide formation was 96.8% or 99.1%, indicating that the formation of acrylamide was highly reduced (see, Example 7).

Thus, the method for reducing the formation of acrylamide according to the present invention allows the effective reduction of acrylamide formation by simple treatment with the pH-lowering agent. Particularly, when applied to foods, the method for reducing the formation of acrylamide according to the present invention allows the effective reduction of acrylamide formation in the foods without affecting the color and flavor of the foods.

### BEST MODE FOR CARRYING OUT THE INVENTION

The present invention will hereinafter be described in further detail by examples. It should however be borne in mind that the present invention is not limited to or by the examples.

### EXAMPLE 1

### Effect of Reduction of Acrylamide Formation in Fried-Corn Chips According to Addition of pH-Lowering Agent

500 ml of each of 0.1% or 0.2% citric acid solutions was added to 500 g of corn grits (coarsely ground to a size smaller than 1 mm), and the mixture was steamed at 121° C. for 60 minutes. The 0.1% and 0.2% citric acid solution treatment is equivalent to 0.1% and 0.2% citric acid addition to corn grits, respectively. Meanwhile, a control group was added with 500 ml of distilled water as substitute for the citric acid solution. The mixture was measured for its pH with a pH meter, cooled and passed several times through rolling rollers to produce thin sheet of corn grit doughs having a thickness of 1 mm. The thin corn sheets were cut to a size of 2×2 cm, and dried at room temperature to make a corn chip bases. The dried corn chip bases were fried with corn oil at 180° C. for 30 seconds to produce fried-corn chips.

10 g of each of the corn chip samples produced as described above was mixed with 50 ml of water, homogenized with a homogenizer, and then filtered through a PVDF membrane (Millipore, 0.45 μm). The filtrate was purified using a graphitized carbonblack column (Alltech, Extract-Clean column Carbongraph).

The amount of acrylamide formed in the purified sample was analyzed by GC-MS (Perkin-Elmer Autosystem XL Gas Chromatograph, Turbomass Mass Spectrometer) according to the method of Tareke et al. (E. Tareke et al., J. Agric. Food Chem., 50, 4998-5006, 2002; E. Tareke et al., Chem. Res. Toxicol., 13, 517-522, 2000) after bromination of acrylamide with saturated bromine solution.

That is, 20 ml of distilled water and 1-8 μg of N,N-dimethylacrylamide as an internal standard were added to and dissolved in the sample. The solution was transferred into a separate vessel and then the volume of the solution in the vessel regulated to be 25 ml. Then, according to the method of Castle et al. (L. Castle et al., J. Sci. Food Agric., 54, 549-551, 1991; and U.S. EPA. SW. 846, US Environmental Protection Agency, Washington D.C., 1996), 3.75 g of potassium bromide and 5 ml of saturated bromine water were added to the solution, and hydrobromic acid was added to the solution until the pH of the solution reaches 2. This gives a brominated derivative. This solution was left to stand at 4° C. overnight, and then few drops of 1M sodium thiosulfate was added to the solution until the yellow color of the solution disappears. This decomposes and removes excess bromine in the solution. Thereafter, the solution was extracted three times with 5 ml of ethyl acetate, and the extract was concentrated to about 2.5 ml with a vacuum rotary evaporator. 0.5-1 ml of the concentrate was taken and nitrogen was introduced into the concentrate to completely evaporate the solvent. Then, the remaining material was dissolved by the addition of 10-15 μl of ethyl acetate, and used as a sample for analysis.

1-2 μl of the sample was injected into a GC-MS injector (250° C.) for analysis. In this case, as a column for GC analysis, there was used a PE-5 column (Perkin-Elmer, 30 m×0.25 mm×0.25 μm), and temperature in analysis was adjusted as follows: kept at 65° C. for 1 minute, elevated to 250° C. at a rate of 15° C./minute, and then kept at 250° C. for 10 minutes. The analysis of the measured results was carried out using electron ionization (70 eV) and selective ion monitoring. Ions monitored for the identification and quantification of 2,3-dibromopropionamide as an analyte were m/z 150 ([C₃H₅⁷⁹BrNO]⁺) and 152 ([C₃H₅⁸¹BrNO]⁺) and the like. N,N-dimethylacrylamide as an internal standard was brominated into 2,3-dibromo-N,N-dimethylpropionamide, and ions monitored for the identification and quantification of 2,3-dibromo-N,N-dimethylpropionamide were m/z 178 ([C₅H₉⁷⁹BrNO]⁺), 180 ([C₅H₉⁸¹BrNO]⁺) and the like.

As a result, the pHs of the corn grits added with distilled water, 0.1% citric acid solution and 0.2% citric acid solution, were 5.7, 4.5 and 4.2, respectively. In other words, it was found that the pH of the corn grits added with 0.1% or 0.2% citric acid solution was lowered 1.2 or 1.5 unit as compared to that of the corn grits added with distilled water.

The amounts of formed acrylamide were 125 ppb (parts per billon) in the control group added with distilled water, 63 ppb in the sample added with 500 ml of 0.1% citric acid solution, and 22 ppb in the sample added with 500 ml of 0.2% citric acid solution, as given in Table 2 below. The inhibition % of acrylamide formation calculated according to the following equation was 49.6% in the sample added with 0.1% citric acid solution and 82.4% in the sample added with 0.2% citric acid solution, as given in Table 1 below.

Thus, it was found that the higher the amount of added citric amount, i.e., the lower the pH, the inhibition % of acrylamide formation was increased.

$$Inhibition \% of acrylamide formation = ( amount of acrylamide formed in control group added with distilled water - amount of acrylamide formed in sample added with citric acid solution ) / amount of acrylamide formed in control group added with distilled water \times 100.$$

TABLE 1
Amount of acrylamide formed in fried-corn chips and inhibition % of
acrylamide formation by citric acid treatment

| | | | Inhibition % of |
|---|---|---|---|
| | Amount of added | Amount of formed | acrylamide |
| | (ml) | acrylamide (ppb) | formation |
| Distilled water | 500 | 125 | — |
| 0.1% citric acid | 500 | 63 | 49.6 |
| solution | | | |
| 0.2% citric acid | 500 | 22 | 82.4 |
| solution | | | |

### EXAMPLE 2

### Sensory Evaluation of Flavor and Color of Fried-Corn Chips Produced with Addition of pH-Lowering Agent According to the Present Invention

The flavor and color of the fried corn chips produced with the addition of citric acid according to Example 1 were compared to the fried corn chips produced with the addition of distilled water.

The flavor of the corn chips was tested using 10 assessors by a discriminative test method where the difference between two samples be discriminated. The comparison in color between the test group and the control group was conducted by observation with the naked eye.

As a result, the flavor of the corn chips was not substantially changed by the addition of citric acid. However, the sample added with 0.2% citric acid solution showed a tendency to be slightly lighter in color. Therefore, it was found that the treatment of foods with the pH-lowering agent according to the present invention did not affect the flavor of foods.

### EXAMPLE 3

### Effect of Reduction of Acrylamide Formation in Baked Corn Chips According to Addition of pH-Lowering Agent

500 ml of 0.1% or 0.2% citric acid solutions was added to 500 g of corn grits, and the mixture was steamed at 121° C. for 60 minutes. Meanwhile, a control group was added with 500 ml of distilled water as substitute for the citric acid solution. After cooling the mixture, thin sheets of corn grit doughs were produced and dried in the same manner as in Example 2 to produce corn chip bases. The corn chip bases were heated in an oven at 255° C. for 1 minute and 40 seconds to produce corn chips. Also, among the corn chip bases, the corn grits treated with the 0.2% citric acid solution were heated in an oven at 255° C. for 2 minutes to produce corn chips. The produced corn chips were purified and then the amount of acrylamide formed in the purified samples was analyzed in the same manner as in Example 1.

As a result, the amounts of formed acrylamide were 151 ppb in the control group added with distilled water, 63 ppb in the sample added with 500 ml of 0.1% citric acid solution, and 41 ppb in the sample added with 0.2% citric acid solution. The inhibition % of acrylamide formation calculated according to the equation of Example 1 from the test results was 58.2% in the sample added with 0.1% citric acid solution, and 72.8% in the sample added with 0.2% citric acid solution, as given in Table 2. Thus, it was found that the higher the amount of added citric acid, i.e., the lower the pH, the higher the inhibition % of acrylamide formation was increased. In the case where the corn grits added with 0.2% citric acid solution were heated in an oven at 255° C. for 2 minutes to produce corn chips, the amount of acrylamide formed in the corn chips was 67 ppb, which is somewhat higher than the corn chips heated for 1 minute and 40 seconds but remarkably lower than the control group.

TABLE 2
Amount of acrylamide formed in baked corn chips and inhibition % of
acrylamide formation

| | | Amount | Amount of | Inhibition % |
|---|---|---|---|---|
| | | of | formed | of |
| | | added | acrylamide | acrylamide |
| Heating time | Treatment | (ml) | (ppb) | formation |
| 1 min and 40 sec | Distilled water | 500 | 151 | — |
| 1 min and 40 sec | 0.1% citric acid | 500 | 63 | 58.2 |
| | solution | | | |
| 1 min and 40 sec | 0.2% citric acid | 500 | 41 | 72.8 |
| | solution | | | |
| 2 min | 0.2% citric acid | 500 | 67 | 55.6 |
| | solution | | | |

### EXAMPLE 4

### Sensory Evaluation of Baked Corn Chips Produced with Addition of pH-Lowering Agent According to the Present Invention

The sensory evaluation of the baked corn chips produced with the addition of citric acid according to Example 3 was conducted in the same manner as in Example 2.

In the evaluation results, the flavor of the baked corn chips was not substantially influenced by the addition of citric acid, and the sample added with 0.2% citric acid solution showed a tendency to be slightly lighter in color. Therefore, it was found that the treatment of foods with the pH-lowering agent did not affect the flavor of foods.

### EXAMPLE 5

### Effect of Reduction of Acrylamide Formation in Fried Potatoes According to Treatment with pH-Lowering Agent

Potatoes for frying were cut to a size of 8 mm×8 mm×50 mm, washed out potato starches on their surface with distilled water, and then dipped in each of 1% and 2% citric solutions for one hour. At this time, the pH of potato juice before dipping and the pH of potato juice after dipping in each of distilled water, 1% and 2% citric solutions were measured with a pH meter. Then, the potatoes were fried with corn oil at 190° C. for 6 minutes and 30 seconds to produce fried potatoes (French fries). Meanwhile, for use as a control group, potatoes were washed only with distilled water, and then treated in the same manner as described above without the dipping process, thereby producing fried potatoes. The produced samples were purified and then the amount of acrylamide formed in the purified samples was analyzed in the same manner as in Example 1.

As a result, the pH of potato juice before dipping was 6.2, and the pHs of potato juice after dipping in distilled water, 1% citric acid solution and 2% citric solution were 6.2, 5.2 and 4.9, respectively. This indicates that the dipping of potatoes in distilled water did not affect the pH of potatoes, and the dipping of potatoes in 1% citric solution and 2% citric solution lowered the pH of potatoes about 1 and 1.3 units, respectively, as compared to the inherent pH of potatoes.

The amounts of formed acrylamide were 796 ppb in the control group undergone no dipping process, 646 ppb in the sample dipped in distilled water, 241 ppb in the sample dipped in 1% citric solution, and 162 ppb in the sample dipped in 2% citric acid solution. The inhibition % of acrylamide formation was calculated from the test results according to the following equation.
Inhibition %=(amount of acrylamide formed in control group−amount of acryl amide formed in each of test groups)/amount of acrylamide formed in control group×100

As a result, the inhibition % of acrylamide formation was 24.9% in the sample dipped in distilled water, 73.1% in the sample dipped in 1% citric acid solution, and 79.7% in the sample dipped in 2% citric acid solution, as given in Table 3 below. This indicates that, even in the case of fried potatoes, the lower the pH, the inhibition % of acrylamide formation was increased. In addition, the fried potatoes produced with dipping in only distilled water showed 25% of inhibition in acrylamide formation. That seemed to be merely due to the leaching out of free asparagines and reducing sugars from the surface layer of potato cuts into the distilled water during dipping.

TABLE 3
Amount of acrylamide formed in fried potatoes and inhibition % of
acrylamide formation

| | Amount of formed | Inhibition % of |
|---|---|---|
| | acrylamide | acrylamide |
| | (ppb) | formation |
| Control group | 796 | — |
| Dipping in distilled water | 646 | 24.9 |
| Dipping in 1% citric acid solution | 214 | 73.1 |
| Dipping in 2% citric solution | 162 | 79.7 |

### EXAMPLE 6

### Sensory Evaluation of Fried Potatoes Produced with Dipping in pH-Lowering Agent According to the Present Invention

The sensory evaluation of the fried potatoes produced with dipping in the pH-lowering agent according to Example 5 was conducted in the same manner as in Example 2.

As a result, the fried potatoes produced with dipping in 1% citric acid solution showed no change in color and flavor. The fried potatoes produced with dipping in 2% citric acid showed no change in color but had a little sour flavor. Therefore, it is confirmed that the limiting level of citric acid solution for pretreatment for French fries is 2% and below. However, in the cases of the baked corn chips and the fried corn chips, the addition of 0.2% citric acid had no effect on the flavor of these corn chips. Therefore, it can be found that the treatment of foods with a suitable amount of the pH-lowering agent can provide a remarkable reduction in acrylamide formation without affecting the flavor of the foods.

### EXAMPLE 7

### Reduction of Acrylamide Formation According to pH

To confirm the mechanism of the reduction of acryamide formation by the pH-lowering agent, the present inventors carried out a test using phosphate buffer model system.

0.5 mmol of asparagine and 0.5 mmol of glucose were added to, and dissolved in 0.1 ml of 0.1M phosphate buffers with different pH(NaH₂PO₄—Na₂HPO₄ buffer for pH 5.0 to 8.0; NaH₂PO₄—H₂PO₄ buffer for pH 4.0). Then, the mixture was put in a mini-vial, sealed, and heated in an oven at 150° C. for 30 minutes to form acrylamide in the mixture. The sample, which had been subjected to the heat treatment, was cooled, and then the amount of acrylamide formed in the sample was analyzed in the same manner as in Example 1.

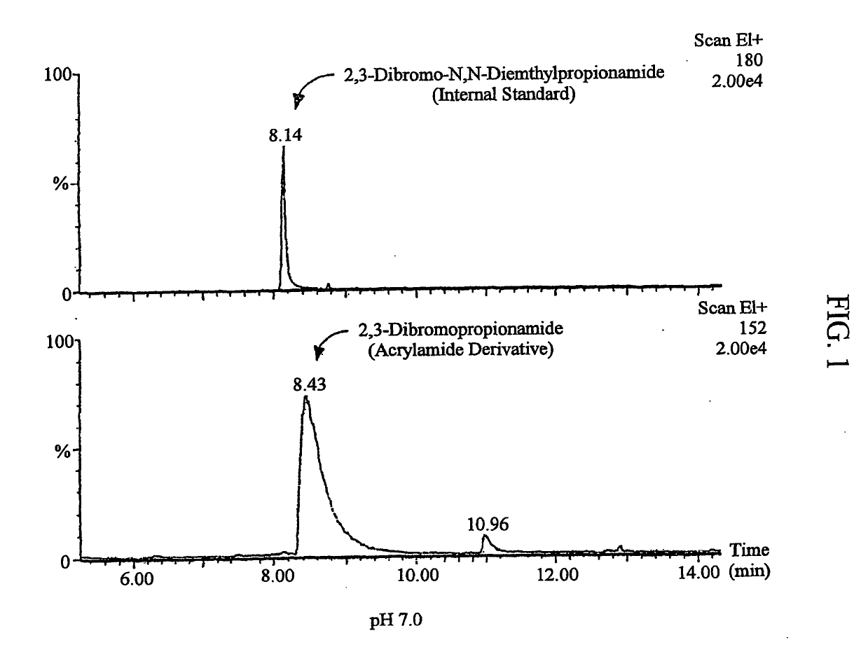

The test results showed that the lower the pH, the formation of acrylamide was remarkably reduced. That is, at pH 8.0, the amount of acrylamide formed per mole of asparagine was 1,455 mg that is the largest amount. And at other pH values, the amount of acrylamide formed per mole of asparagines was 1,413 mg at pH 7.0, 377 mg at pH 6.0, 47 mg at pH 5.0, and 13 mg at pH 4.0. FIG. 1 is the chromatograms of acrylamide and an internal standard, which were measured by GC-MS at pH 7.0. The inhibition percentage in acrylamide formation calculated according to the following equation was 2.9% at pH 7.0, 74.1% at pH 6.0, 96.8% at pH 5.0, and 99.1% at pH 4.0, as given in Table 4 below.

$$Inhibition \% of acrylamide formation = ( amount of acrylamide formed at pH 8 - amount of acrylamide formed at each pH ) / amount of acrylamide formed at pH 8 \times 100$$

TABLE 4
Amount of formed acrylamide in model system of phosphate buffer and
inhibition % of acrylamide formation according to pH

| | Amount of acrylamide formed | Inhibition % of |
|---|---|---|
| PH | (mg/mol asparagines) | acrylamide formation |
| 8.0 | 1455 | — |
| 7.0 | 1413 | 2.9 |
| 6.0 | 377 | 74.1 |
| 5.0 | 47 | 96.8 |
| 4.0 | 13 | 99.1 |

As evident from the above results, it was found that the lowering pH could be effectively reduced the formation of acrylamide. Thus, the present inventors have directly applied the method for reducing the formation of acrylamide to foods in order to determine if the inventive method effectively reduce the formation of acrylamide in the foods.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

The entire disclosure of Korea Patent Application No. 2003-0000391, filed on Jan. 3, 2003 and Korea Patent Application No. 2003-0042189, filed on Jun. 26, 2003 including its specification, claims, drawings and summary are incorporated herein by reference in its entirety.

### INDUSTRIAL APPLICABILITY

As described in Examples above, the method for reducing the formation of acrylamide according to the present invention has the effect of allowing the formation of acrylamide to be greatly reduced. Particularly, when applied to foods, the inventive method has the effect of allowing the formation of acrylamide to be highly reduced without affecting the flavor and color of the foods.

What is claimed is:

1. A method for the reduction of acrylamide formation, comprising the step of protonating a nucleophilic α-amino group (—NH₂), thereby converting into a non-nucleophilic amine (—NH₃⁺), as shown in the following Scheme 2:

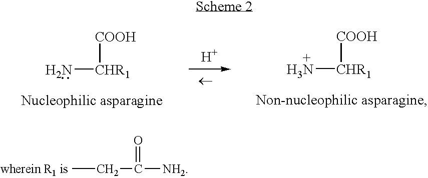

2. The method of claim 1, wherein the protonation of the nucleophilic amino group is carried out by treatment with a pH-lowering agent.

3. The method of claim 2, wherein the pH-lowering agent is used for the treatment of foods or food ingredients.

4. The method of claim 3, wherein the treatment foods or food ingredients with the pH-lowering agent is carried out before subjecting the foods to heat treatment.

5. The method of claim 4, wherein the treatment foods or food ingredients with the pH-lowering agent is preformed by adding, mixing, spraying or soaking.

6. The method of claim 4, wherein the heat treatment is selected from the group consisting of frying, baking, roasting, high temperature extrusion, and high temperature injection.

7. The method of claim 3, wherein the foods contain at least one selected from the group consisting of amino acids, sugars and carbonyl compounds.

8. The method of claim 7, wherein the foods are carbohydrate foods.

9. The method of claim 3, wherein the treatment of the foods with the pH-lowering agent is conducted such that the pH of the foods or food ingredients is 0.1-3.0 units lower than the intrinsic pH of the foods or food ingredients.

10. The method of claim 3, wherein the pH-lowering agent is added to the foods or food ingredients at a concentration of 0.001-10.0%.

11. The method of claim 3, wherein the pH-lowering agent is selected from the group consisting of organic acid or its salt, buffer solution containing the organic acid or its salt, inorganic acid or its salt, buffer solution containing the inorganic acid or its salt, fruit juice, and a mixture thereof.

12. The method of claim 11, wherein the organic acid is selected from the group consisting of citric acid, malic acid, acetic acid, lactic acid, succinic acid, tartaric acid, ascorbic acid, and adipic acid.

13. The method of claim 11, wherein the inorganic acid is selected from the group consisting of phosphoric acid, hydrochloric acid, sulfuric acid and pyrophosphoric acid.

14. The method of claim 11, wherein the salt of inorganic acid is monosodium phosphate or monopotassium phosphate.

15. The method of claim 11, wherein the buffer solution is selected from the group consisting of sodium phosphate buffer solution, potassium phosphate buffer solution, citric acid-sodium citrate buffer solution, and citric acid-sodium phosphate buffer.

16. The method of claim 11, wherein the fruit juice is selected from the group consisting of lemon juice, plum juice, apricot juice, orange juice, citron juice and lime juice.
